(19) United States
(12) Patent Application Publication
(10) Pub. No.: US 2003/0201620 A1
(43) Pub. Date: Oct. 30, 2003

(54) Skateboard riser light

(76) Inventor: Scott Jonathan Seelye, Corvallis, OR (US)

Correspondence Address: Scott J. Seelye, 5068 SW Technology Loop #117, Corvallis, OR, 97333, US

(21) Appl. No.: 10/128,502

(22) Filed: Apr. 24, 2002

(51) Int. Cl. B62M 1/00; A63C 17/01

(52) U.S. Cl. 280/87.042

(57) ABSTRACT

A skateboard light embodied as a riser used between the skateboard deck and truck assembly. The skateboard riser light includes an LED lamp that is bright enough to be used as headlights on skateboards. The skateboard riser light is powered by lithium cell batteries, which are compact and long lasting. The skateboard riser light uses a slide switch to turn the light off and on.

### FIELD OF INVENTION

The present invention relates to skateboard lights and more particularly to a skateboard light embodied as a skateboard riser.

### BACKGROUND OF INVENTION

For the last 30 years, the basic components of the skateboard have remained the same. A skateboard is made up of a deck, axle assembly, and wheel assembly. Few additional components have been added due to the abuse that they are subjected to, and that they may be obtrusive.

Presently, skateboarders are limited to riding in the daylight, unless headlights are attached to the skateboard. The rules and regulations have been directly adopted from the same rules and regulations for bicycles.

While attempts have been made to attach lights to the skateboard, none have been able to withstand the abuse subjected during average skateboard use, and were only bright enough to be used for decorative purposes.

Recent advancements in light emitting diodes (LED), lithium cell batteries, and high impact plastic materials, have warranted the invention of the skateboard riser light.

Skateboarders commonly use the riser as a spacer between the deck and the truck assemblies to offset the wheels from the deck, and to further prevent the wheels from rubbing against the bottom side of the deck.

Advancements in LED technology have created lamps with the power to be used for headlights on skateboards, and with smaller and more powerful lithium cell batteries, these LED lamps can be used in skateboard headlights that last long enough to be practical and inexpensive.

By locating the headlights in the presently used riser locations, the abuse subjected during average skateboard use is minimized.

### SUMMARY OF INVENTION

It is therefore an object of the invention to provide a novel construction for a skateboard headlight. It is another object that the device be readily adaptable to presently used components of the skateboard. It is another object that the device is made of materials, which withstand damage from normal use. It is another object that the device be designed to be unobtrusive to normal skateboard use. It is another object that the device be universally used on the front or the rear ends of the skateboard. It is another object of the invention that the LED is bright enough to be used as a headlight.

### BREIF DESCRIPTION OF THE DRAWINGS

FIG. 1 is an exploded view of a conventional skateboard and showing the placement of the skateboard riser light.

FIG. 2 is a bottom plan view of the skateboard of FIG. 1.

FIG. 3 is an exploded view of the skateboard riser light assembly.

FIG. 4 is a top plan view of the assembled skateboard riser light less the upper case half.

### DETAILED DESCRIPTION OF THE PREFERRED EMBODIMENTS

The following description is provided to enable any person skilled in the art to make and use the invention and set forth the best modes contemplated by the inventor of carrying out the invention. Various modifications, however, will remain apparent to those skilled in the art, since the general principles of the present invention have been defined herein.

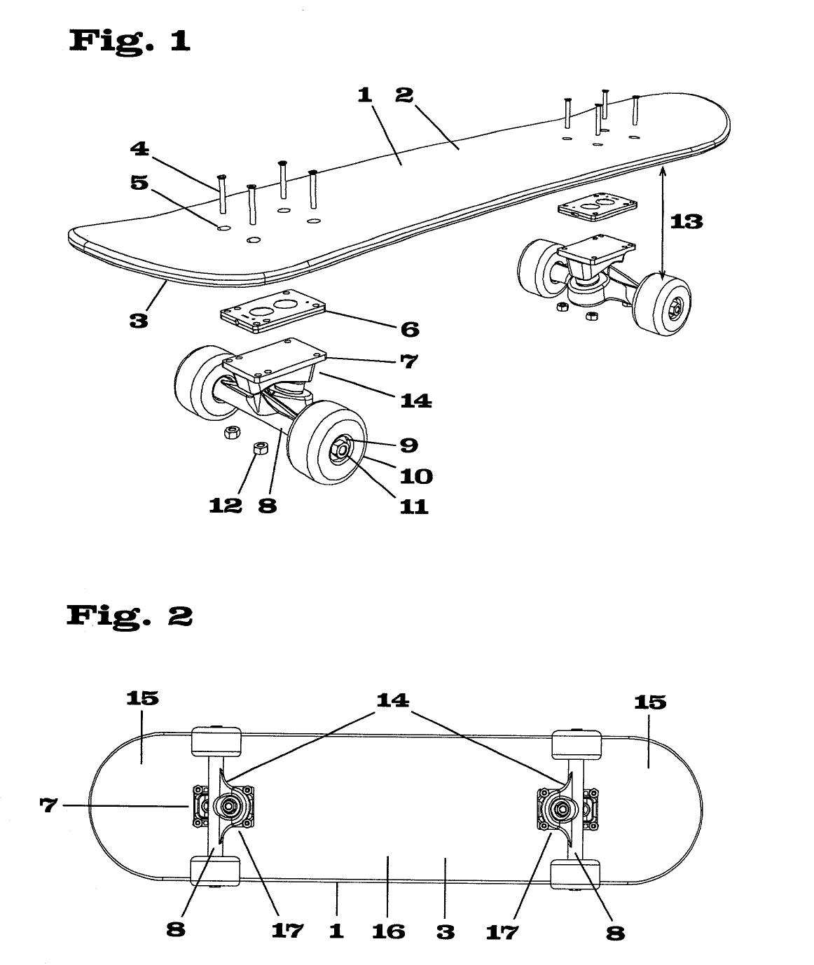

Referring now to FIG. 1, there is shown a typical skateboard assembly, which comprises a deck 1 with a topside 2 and a bottom side 3, a truck assembly 14, which comprises a baseplate 7, an axle 8, wheels 10, wheel bearings 9, and the wheel nuts 11. The skateboard riser light 6 is assembled between the bottom of deck 3 and the baseplate 7. The skateboard riser light 6 and the truck assembly 14 are mounted to the deck 1 with truck mounting bolts 4, which are located thru the truck mounting thru holes 5, thru the skateboard riser light 6, and thru the truck assembly 14. Finally, a nut 12 is threaded onto the truck mounting bolts. Item 13 shows the additional space between the bottom of deck 3 and the wheels 10.

Referring now to FIG. 2, there is shown the outer portion 15 of bottom of deck 3 and the bottom of deck between 16 truck assemblies 14, and the axle 8, which are the surfaces presently used by skateboarders for sliding along structures made of metal, wood, or concrete. Also shown, is the edge surrounding 17 the baseplate 7 and the skateboard riser light 6, which should not be obtrusive to the surfaces noted above.

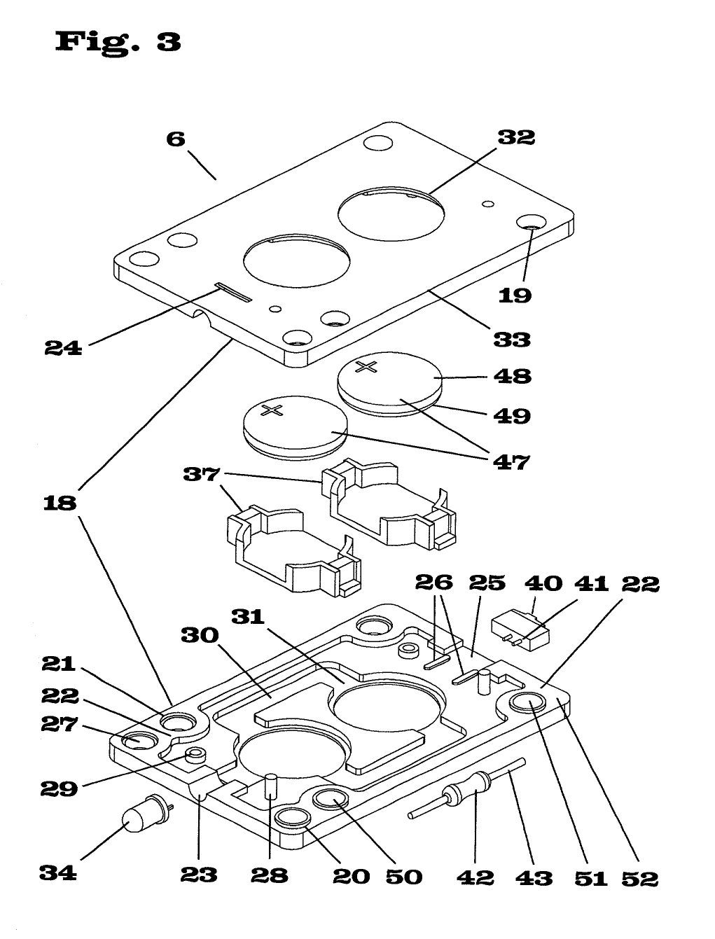

Referring now to FIG. 3, shown are the components comprising the skateboard riser light 6. The skateboard riser light 6 included a pair of case halves 18, which is to be preferably made from an impact resistant material such as polycarbonate, nylon, UHMW (ultra high molecular weight), urethane, or similar material. Alternatively, the case halves 18 can be made of materials such as aluminum, titanium, brass, and similar materials. The case half 18 is comprised of thru holes 51 with a recent hole pattern 50 and an older hole pattern 27. The case half thru holes 51 are surrounded by pillars 22, which direct the impact away from the electronic components. The case half 18 includes an LED cradle 23 to position the LED 34, a switch cradle 25 and a set of switch bosses 26 to position the switch 40. A battery holder recess 31 is used to position the battery holder 37. A resistor recess 30 is used to position the resistor 42. When the case halves 18 are positioned so that the inner surfaces 52 are facing each other, the press pin 28 from one will align with the press pin receiver 29 from the other. The case half shall have a radius or fillet 33 as apposed to a sharp edge, which may damage the bottom of the deck 3. An LED relief 24 is added for locating the LED 34 and to minimize any stress on the LED 34. The case half has a battery access hole 32, which provides a means of removing the battery 47 for replacement. The lithium cell battery 47 is pushed into a battery holder 37, and in turn, the battery holder 37 placed into the battery holder recess 31.

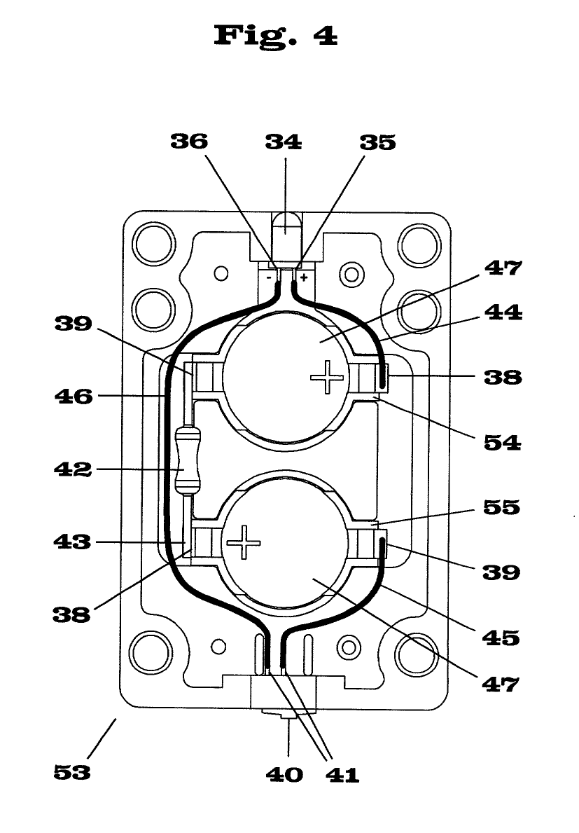

Referring now to FIG. 4, there is shown the components that comprise the light circuit 53. The LED 34, battery holders 37 with batteries 47, and switch 40 are placed in a manner described above. Wire 44 is attached to the LED positive lead 35 and the battery holder positive terminal 38. The resistor 42 is attached to the battery holder negative terminal 39 of the first battery holder positioned with the negative terminal facing left 54 and the battery holder positive terminal 38 of the battery holder with the negative terminal facing right 55. Wire 45 is attached to the battery holder negative terminal 39 and a switch lead 41 on switch 40. A final wire 46 is attached to the remaining switch lead 41 on the switch 40 and the LED negative lead 36. The light circuit 53 is wired in a series fashion. The Resistor 42 is added to regulate the voltage that the batteries 47 are supplying to the LED 34.

Those skilled in the art will appreciate that various adoptions and modifications of the invention as described above can be configured without departing from the scope and spirit of the invention. Therefore, it is to be understood that, within the scope of appended claims, the invention may be practiced other than as specifically described herein.

What is claimed is:

1. A skateboard lighting adapter for skateboards of the type having a deck and at least one truck assembly, said skateboard lighting adapter comprising:
a) a light source,
b) a power source,
c) a switch adapted to for energizing said light source, and
d) a case for housing said light source and power source, said case having top and bottom major surfaces, said case being adapted for mounting below said deck and between said deck and said at least one truck assembly, whereby said case functions further as a riser.

2. A skateboard lighting adapter as recited in claim 1, said deck having a bottom surface, wherein said top major surface of said skateboard lighting adapter is adapted to conform to said bottom surface of said deck of said skateboard.

3. A skateboard lighting adapter as recited in claim 2, wherein said top major surface of said skateboard lighting adapter is substantially flat.

4. A skateboard lighting adapter as recited in claim 1, said at least one truck assembly having a top surface wherein said bottom major surface of said skateboard lighting adapter is adapted to conform to said top surface of said at least one truck assembly of said skateboard.

5. A skateboard lighting adapter as recited in claim 4, wherein said bottom major surface of said skateboard lighting adapter is substantially flat.

6. A skateboard lighting adapter as recited in claim 1, wherein said skateboard lighting adapter is adapted for being clamped between said bottom surface of said deck and said top surface of said at least one truck assembly of said skateboard.

7. A skateboard lighting adapter as recited in claim 1, said at least one truck assembly using mounting screws, said skateboard lighting adapter further comprising openings disposed to match locations of said mounting screws.

8. A skateboard lighting adapter as recited in claim 1, wherein one or more LED lamps are used as the light source.

9. A skateboard lighting adapter as recited in claim 8, wherein said LED lamp emits a white light.

10. A skateboard lighting adapter as recited in claim 1, wherein a switch is used for energizing said light source.

11. A skateboard lighting adapter as recited in claim 1, wherein one or more cell batteries are used as said power source.

12. A skateboard lighting adapter as recited in claim 1, wherein said case is made of high impact material such as polycarbonate plastic.

13. A skateboard lighting adapter for skateboards of the type having a deck with a bottom surface and at least one truck assembly with a top surface and mounting screws, said skateboard lighting adapter comprising:
a) a light source,
b) a power source,
c) a switch adapted to for energizing said light source, and
d) a case for housing said light source and power source, said case having a top major surface conforming to said bottom surface of said deck, a bottom major surface conforming to said top surface of said truck assembly, and openings disposed to match locations of said mounting screws,
whereby said case is adapted for mounting below said deck and clamped between said deck and said at least one truck assembly, whereby said case functions further as a riser.

14. A skateboard lighting adapter as recited in claim 13, wherein one or more LED lamps are used as the light source.

15. A skateboard lighting adapter as recited in claim 14, wherein said LED lamp emits a white light.

16. A skateboard lighting adapter as recited in claim 13, wherein a switch is used for energizing said light source.

17. A skateboard lighting adapter as recited in claim 13, wherein one or more cell batteries are used as said power source.

18. A skateboard lighting adapter as recited in claim 13, wherein said case is made of high impact material such as polycarbonate plastic.
